(19) United States
(12) Patent Application Publication
(10) Pub. No.: US 2023/0279887 A1
(43) Pub. Date: Sep. 7, 2023

(54) QUICK CHANGE DEVICE FOR COUPLING COOKING COMPONENTS

(71) Applicant: W.C. BRADLEY CO., Columbus, GA (US)

(72) Inventors: DAN CORSO, Columbus, GA (US); BRIAN BARNETT, FORTSON, GA (US); BRAD GILLESPIE, Midland, GA (US); SCOTT LAWRENCE WAYLAND, Columbus, GA (US); MICHAEL PARSONS, Auburn, AL (US)

(21) Appl. No.: 18/116,145

(22) Filed: Mar. 1, 2023

Related U.S. Application Data
(60) Provisional application No. 63/315,261, filed on Mar. 1, 2022.

(51) Int. Cl. F16B 12/40; A47J 37/07; F16B 12/36

(52) U.S. Cl. CPC F16B 12/40; A47J 37/0786; F16B 12/36

(57) ABSTRACT

A first bracket affixes to a first cooking component body and defines a first passageway therethrough. A second bracket affixes to a second cooking component body and defines a second passageway therethrough. The first and second brackets may be joined together to form a continuous passageway from the first cooking component body to the second cooking component body.

### CROSS-REFERENCE TO RELATED CASES

This application claims the benefit of U.S. provisional patent application Ser. No. 63/315,261, filed on Mar. 1, 2022, and incorporates such provisional application by reference into this disclosure as if fully set out at this point.

### FIELD OF THE INVENTION

This disclosure relates to coupling mechanisms in general and, more specifically, to an adaptable coupling mechanism useful with multi-piece cooking devices.

### BACKGROUND OF THE INVENTION

Currently, barrel-type cookers are made in a number of configurations. In one configuration a main horizontal cylinder is constructed with an openable lid and a cooking grate that is exposed when the lid is opened. A solid fuel fire grate or container is provided below the cooking grate with an exhaust opening or openings above the cooking grate. An air inlet is provided in the end of the horizontal cylinder with an adjustable air vent.

In another configuration the air inlet at the end of the horizontal cylinder is replaced by a solid fuel container in the form of a generally smaller horizontal cylinder with a solid fuel rack in the cylinder. An opening on one end of the smaller cylinder corresponds to the air opening on the end of the main horizontal cylinder. An air inlet on the other end of the smaller cylinder may have an adjustable gate or damper. These configurations may be generally described in practice as an offset smoker.

In another configuration, the smaller cylinder can be provided separately with or without legs to allow standalone use of the smaller cylinder. In such cases a cooking grate may be installed above the solid fuel rack. In order to carry out the conversion from two separate devices to a single device, it was necessary to use multiple threaded fasteners. Challenges to such an arrangement included, but were not limited to: extended lengths of time required to obtain a strong and leak resistant connection; difficulty of access to fasteners inside the cylinders; the requirement to position the mating parts while simultaneously installing the fasteners; the consequent likelihood of needing two people to install; and rust and deterioration of the fasteners exposed to the flow of hot and potentially corrosive gases. Conversion back to separate devices is equally problematic.

What is needed is a system and method for addressing the above and related issues.

### SUMMARY OF THE INVENTION

The invention of the present disclosure, in one aspect thereof, comprises a coupling system for joining a first cooking component body to a second cooking component body. The system includes a first bracket affixed to the first cooking component body and defining a first passageway therethrough, and a second bracket affixed to the second cooking component body and defining a second passageway therethrough. The first and second brackets may be joined together to form a continuous passageway from the first cooking component body to the second cooking component body.

The system may further include a slot defined by a fold at a top of the second bracket that receives a tab defined at a top of the first bracket. The first bracket may comprise a first back plate affixed to the first cooking component body and a first collar proceeding therefrom, a first pair of side flanges on the first bracket collar, and a lower flange on the first bracket collar, the lower flange having at least a first laterally oriented sleeve thereon. The second bracket may comprise a back plate affixed to the second cooking component and a collar proceeding therefrom, a second pair of side flanges on the second bracket collar, and a lower flange on the second bracket collar, the lower flange having at least a second laterally oriented sleeve thereon. The system may further comprise a removable pin proceeding through the first laterally oriented sleeve on the first bracket collar and the second laterally oriented sleeve on the second bracket collar. Some embodiments further comprise a pair of spaced apart protruding tabs, one on each of the first pair of slide flanges on the first bracket collar.

The system may include an end plate sized to be fitted against the first pair of side flanges of the first bracket between the spaced apart protruding tabs when the first and second brackets are separated, having a third laterally oriented sleeve to receive the removable pin when fitted onto the side flanges, and having a top slot to receive the tab when fitted onto the side flanges, the end plate providing a damper valve to control airflow into and out of the first passageway.

In some cases, the system includes an end plate with protruding tabs sized to be fitted onto the second pair of side flanges of the second bracket with the tabs outside the side flanges when the first and second brackets are separated, the end plate further having a top tab fitting into the slot of the second bracket, and providing a third laterally oriented sleeve to receive the removable pin when the removable pin is also inserted into the second laterally oriented sleeve, the end plate providing a damper valve to control air flow into and out of the second passageway.

In some embodiments, the first bracket comprises a first set of studs that selectively fit with a first set of keyhole slots defined in the second bracket. The set of keyhole slots may be defined in a pair of flanges that extend laterally from a collar of the second bracket. The set of studs may be affixed to a pair of side flanges that extend laterally from the first bracket.

The collar of the first bracket may be affixed to the first cooking component body by a first backing plate on an opposite end of the first collar from the second set of side flanges, and the collar of the second bracket may be affixed to the second cooking component by a second backing plate on an opposite end of the second collar from the first set of side flanges.

Some systems further comprising an end plate defining a second set of keyhole slots that receives the first set of studs such that the end plate covers the first bracket when the first and second brackets are separated, the end plate providing a damper valve to control air flow into and out of the first passageway. Some systems may include an end plate supporting a second set of studs such that the end plate covers the second bracket when the first and second brackets are separated, the end plate providing a damper valve to control air flow into and out of the passageway.

The invention of the present disclosure, in another aspect thereof, comprises a coupling system for joining a first cooking component body to a second cooking component body. The system has a first bracket affixed to the first cooking component body defining a first passageway through the first bracket, and a second bracket affixed to the second cooking component body and defining a second passageway through the second bracket. The first and second brackets may be joined together to form a continuous passageway from the first cooking component body to the second cooking component body. The first bracket defines a first pin passageway and the second bracket defines a second pin passageway such that the first and second pin passageways align to receive a retaining pin when the first and second bracket are joined together.

The system may have a tab and slot arrangement between the first bracket and the second bracket such that the tab is retained in the slot when the first and second brackets are joined together. The tab and slot arrangement and the first and second brackets may be spaced apart from the respective cooking component bodies by first and second collars on the first and second brackets defining the first and second passageways, respectively.

Some systems further comprise at least one end plate defining a third pin passageway such that the end plate fits over the first passageway when the first and second brackets are separated and the retaining pin is inserted through the first and third pin passageways.

The invention of the present disclosure, in another aspect thereof, comprises a coupling system for joining a first cooking component body to a second cooking component body. The system includes a first bracket affixed to the first cooking component body and defining a first passageway through the first bracket, a second bracket affixed to the second cooking component body and defining a second passageway through the second bracket, a first set of studs affixed to the first bracket, and a first set of key slots defined in the second bracket. The first and second brackets may be joined together to form a continuous passageway from the first cooking component body to the second cooking component body when the first set of studs are received by the first set of key slots. The first set of studs and the first set of key slots are spaced apart from the first component cooking body and the second component cooking body by first and second collars of the first and second brackets, respectively.

In some cases, the first bracket defines a first set of flanges affixed to the first collar to which the first set of studs are affixed, and the second bracket defines a second set of flanges in which the first set of key slots are defined.

The system may include an end plate defining a second set of key slots that receives the first set of studs and blocks the first passageway when the first and second brackets are separated, the end plate having a damper. The system may include an end plate defining a second set of studs that are received by the first set of key slots and blocks the second passageway when the first and second brackets are separated.

### BRIEF DESCRIPTION OF THE DRAWINGS

FIG. 1 is an end perspective view of a cooking grill with a coupling bracket according to aspects of the present disclosure.

FIG. 2A is an end perspective view of the cooking grill of FIG. 1 with a damper door removed from the bracket.

FIG. 2B is a side view of the bracket of FIG. 1.

FIG. 2C is an end view of the bracket of FIG. 1.

FIG. 3 is an end perspective view of an offset smoker box with coupling bracket according to aspects of the present disclosure.

FIG. 4A is an end perspective view of the offset smoker box of FIG. 3 with a damper door removed from the bracket.

FIG. 4B is a side view of the bracket of FIG. 3.

FIG. 4C is an end view of the bracket of FIG. 3.

FIG. 5 is a closeup side view of the cooking grill of FIG. 1 joined to the offset smoker box of FIG. 3 utilizing the respective brackets to form an offset smoker.

FIG. 6 is a perspective view of a main cylinder of a cooking grill with a keyhole coupling bracket according to aspects of the present disclosure.

FIG. 7 is a perspective view of an offset cylinder with a stud bracket corresponding to the keyhole bracket of FIG. 6.

FIG. 8 is a perspective view of a keyhole bracket with removable indexed vent cover according to the present disclosure.

FIG. 9 is a perspective end view of an offset smoker with a stud bracket and attached removable indexed vent cover according to the present disclosure.

FIG. 10 is a side closeup view of the cooking grill of FIG. 6 joined to the offset smoker box of FIG. 7 utilizing their respective brackets to form an offset smoker.

### DETAILED DESCRIPTION OF THE PREFERRED EMBODIMENTS

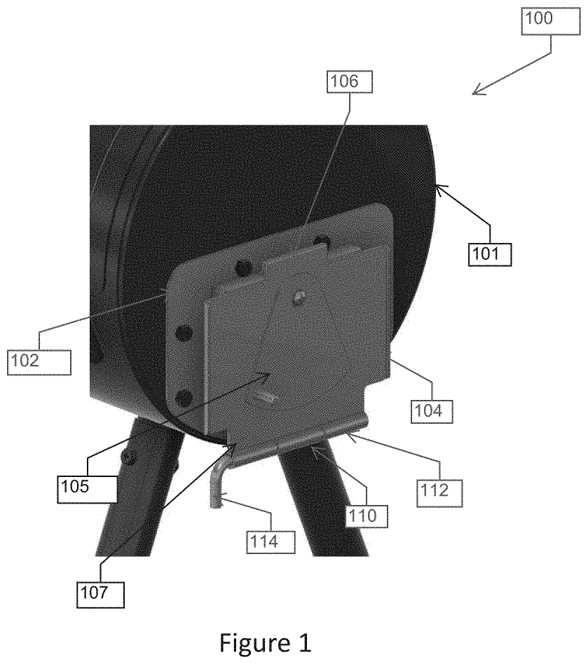

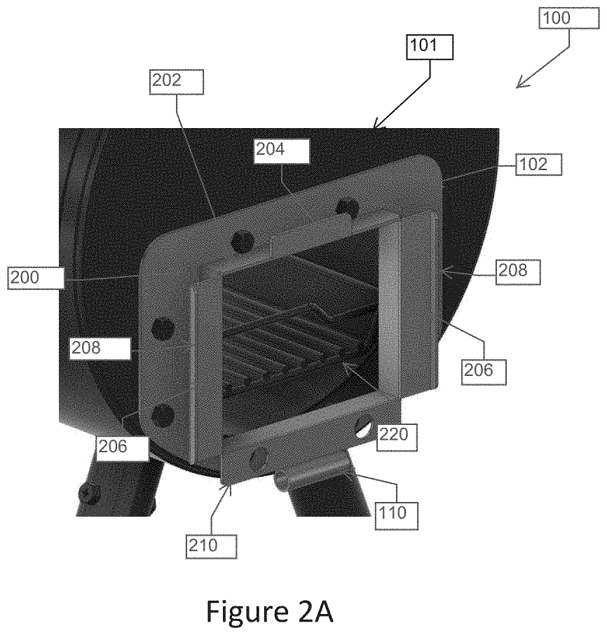

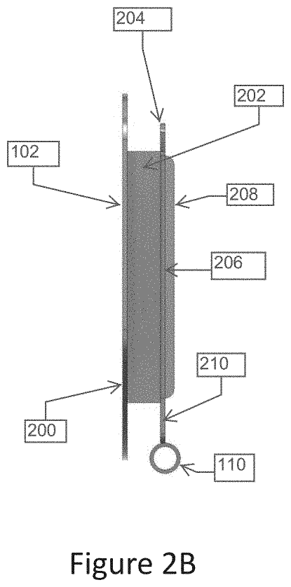

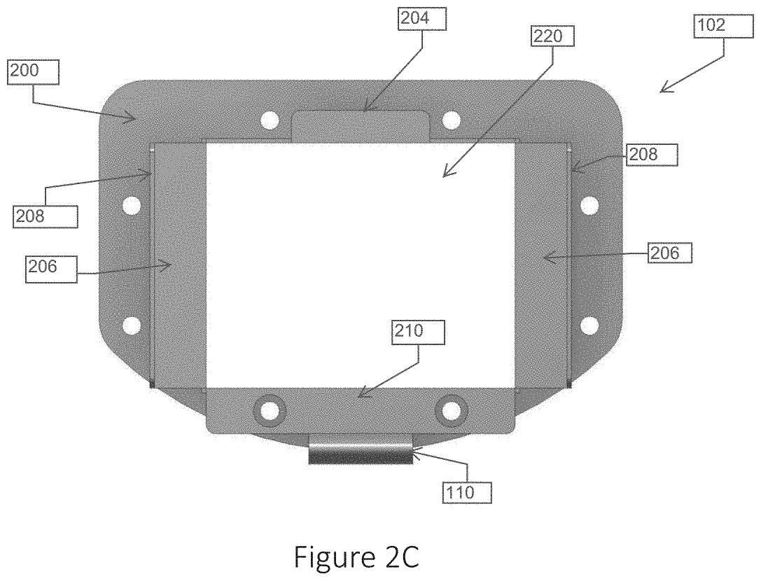

Reference may now be made to the accompanying Figures wherein various embodiments of the present disclosure are illustrated. FIG. 1 is an end perspective view of a cooking grill 100 with a coupling bracket 102 according to aspects of the present disclosure. FIG. 2A is an end perspective view of the cooking grill 100 of FIG. 1 with a cover plate 104 removed from the bracket 102; FIG. 2B is a side view of the of the bracket 102 of FIG. 1; and FIG. 2C is an end view of the bracket 102 of FIG. 1.

The cooking grill 100 may have a cylindrical body 101. It should be understood that the term “cylinder” is used herein to refer to the body of the separate or combined cooking device(s). Historically, cylindrical bodies are utilized for cooking device for various reasons. However, it should also be appreciated that the brackets and coupling system of the present disclosure do not necessarily require that the cooking bodies that are attached together have cylindrical shapes. The bracket 102 may be installed on one end or the other of the body 101. When the body 101 is not connected to an additional cooking chamber or offset smoker, the cover plate 104 may be placed on the bracket. The plate 104 may have a damper valve 105 for admitting or restricting airflow into the body 101. The plate 104 may be substantially planar.

The plate 104 may have a top slot or fold 106 that receives a tab 204 (FIG. 2) on the bracket 102. The plate 104 may be sized to fit within protruding tabs 208 on side flanges 206 of the bracket 102. A bottom end 107 of the plate 104 may have a pair of sleeves 112 that line up on either side of a sleeve 110 on the bracket 102 when the plate 104 is installed. In another embodiment, multiple sleeves on the bracket 102 cooperate with one or more sleeves on the plate 104. A common pin 114 may pass through all sleeves and complete a secure connection of the plate 104 to the bracket 102. Removal of the pin 114 may be accomplished without tools. This allows the plate 104 to be removed by sliding upward such that the slot 106 clears the tab 204.

In the views of FIGS. 2A-2C with the plate 104 removed, the bracket 102 can be seen to comprise a back plate 200 defining an opening 220 for passage of gas, heat, and/or combustion products into the body 101. The back plate 200 may attach to the body 101 by welding, screws, bolts rivets, or other fasteners (other back plates and brackets of the present disclosure may similarly attach to respective bodies by welding, screws, bolts rivets, or other fasteners).

A collar or short conduit 202 may protrude from the back plate 200. Spaced from the back plate 200 the collar 202 may provide a pair of opposite side flanges 206 with protruding tabs 208 spaced apart from the collar 202. A lower flange 210 may provide a location for the sleeve 110. Tab 204 may be located along the top of the collar 202. In some embodiments, the side flanges 206, the tab 204, and the lower flange 210 are co-planar and present surfaces against which the plate 104 may be securely fitted such that minimal fluid flow is allowed to pass. They also provide surfaces for mating against a cooperating bracket for attachment of additional cooking bodies as described herein.

The conduit or collar 202 is shown as having a square or rectilinear cross section. While this configuration provides some benefits in terms of geometry and ease of production, other embodiments are not square in cross section (e.g., they may be circular, oblong, or polygonal).

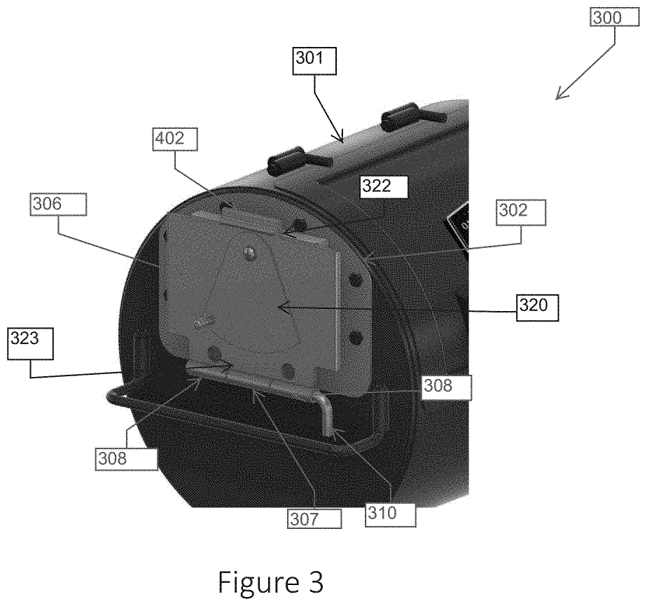

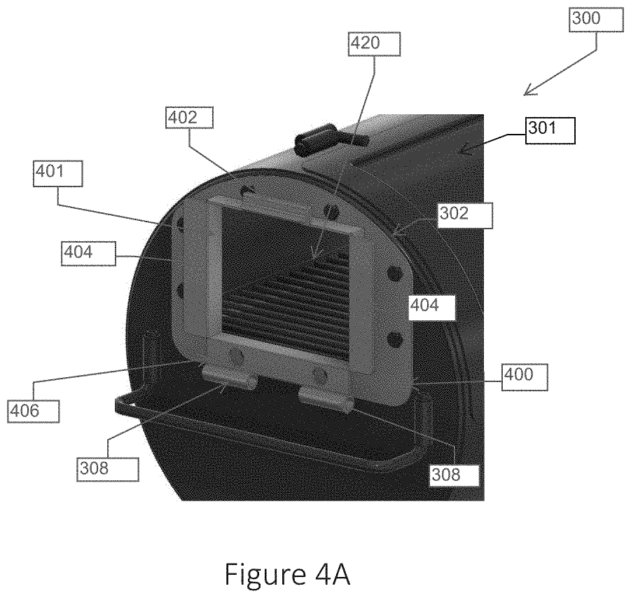

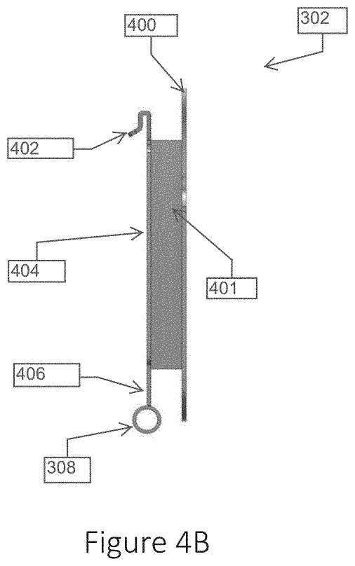

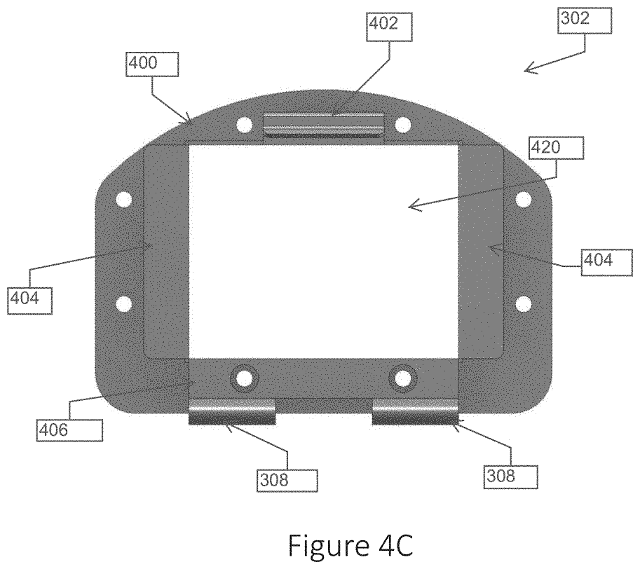

Referring now to FIG. 3, an end perspective view of an offset smoker box 300 with coupling bracket 302 according to aspects of the present disclosure is shown. FIG. 4A is an end perspective view of the offset smoker box 300 of FIG. 3 with a cover plate 306 removed from the bracket 302; FIG. 4B is a side view of the bracket 302 of FIG. 3; FIG. 4C is an end view of the bracket 302 of FIG. 3.

The offset smoker box 300 may comprise a cylindrical body 301. The body 301 is not necessarily cylindrical in all embodiments, and may represent a firebox, side smoker, and/or separately useable cooking device. The bracket 302 is installed on one end of the body 301. The bracket 302 may be installed on the body 301 such that it may be conveniently joined to the body 101 of the cooking grill 100 as described herein. When the smoker box 300 is used alone, the cover plate 306 having an adjustable damper door 320 may be fitted onto the bracket 302.

A top fold or slot 402 defined by the bracket 302 may receive an upper portion of the plate 306 or a tab 322 extending therefrom. The plate 306 may provide a sleeve 307 along a lower portion 323 thereof that fits between spaced apart sleeves 308 on the bracket 302. A common pin 310 may pass through all sleeves and secure the plate 306 against vertical or lateral movement when installed on the bracket 302. Removal of the pin 310 may allow the plate 306 to slide free of the slot 402 and off of the bracket 302.

In FIGS. 4A-4C with the plate 306 removed, it can be seen that the bracket 302 comprises a back plate 400 that is affixes to the end of the body 301. The back plate 400 may attach or affix by welding, screws, bolts rivets, or other fasteners. The back plate 400 defines an opening 420 to admit combustion air into the body 301 and/or allow escape of combustion air when the body 301 is utilized as a side smoker or firebox.

A short conduit or collar 401 extends from the back plate 400 around the opening 420. Opposite the back plate 400 the collar 401 provides side flanges 404. A bottom flange 406 provides locations for the sleeves 308. The side flanges 404, the bottom flange 406, and the inner portion of the slot 402 are coplanar and provide surfaces against which the plate 306 and/or bracket 102 can mate forming a passageway that is substantially free of fluid leakage. Additionally, the collar or conduit 401 is rectilinear in cross section as shown, and has some benefits associated with geometry and ease of production. In other embodiments the conduit 401 may have a cross section that is round, oblong, or polygonal.

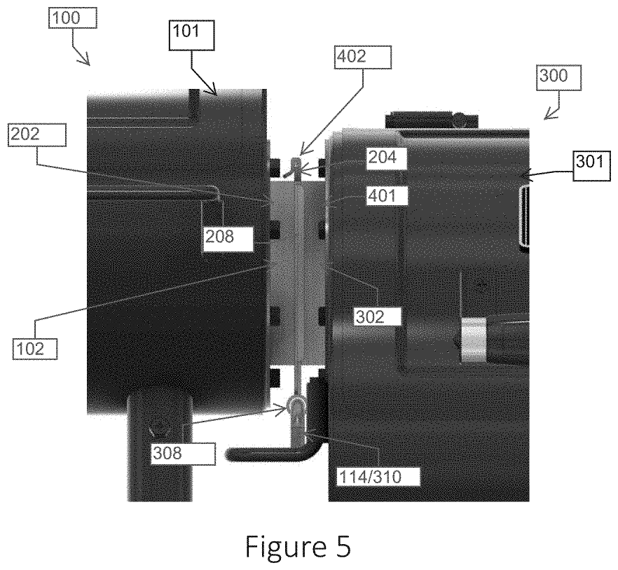

FIG. 5 is a closeup side view of the cooking grill 100 of FIG. 1 joined to the offset smoker box 300 of FIG. 3 utilizing the respective brackets 102/302 to form an offset smoker. The tab 204 of bracket 102 is fitted into the slot 402, while the side flanges 404 are abutted against the slide flanges 206, and may be nested between the tabs 208. Lower flanges 210, 406 may be abutted with the sleeve 110 fitted between the sleeves 308. A common pin 114/310 may pass through the sleeves 110/308 and lock the brackets 102/302 together. Thus a passageway is formed between the bodies 101/301 allowing smoke and combustion products to pass.

It should be understood that the bracket 102 could be attached to the body 301 of the smoker box 300; and the bracket 302 could be attached to the body 101 of the cooking grill 100. In such case the brackets 102, 302 and their associated components would be reversed from how they are illustrated but the operation of the coupling system would otherwise be substantially similar.

The details of the mating features are shown in particular embodiments but do not constitute the sole methods of providing such features. For example, in further embodiments the plane of the air openings, adjustable air inlet and mating brackets are at an angle (rather than substantially vertical as shown) to create certain mechanical or functional advantages.

It will be immediately apparent that connection and disconnection of the smaller cylinder 300 from its offset location on the end of the main cylinder 100 can be effected in a simple operation without tools and threaded fasteners allowing the conversion to proceed more expeditiously. It will further be seen that the mating elements that establish the connection of the brackets 102, 302 are not exposed to hot and potentially corrosive gases and therefore are less likely to deteriorate and become non-functional.

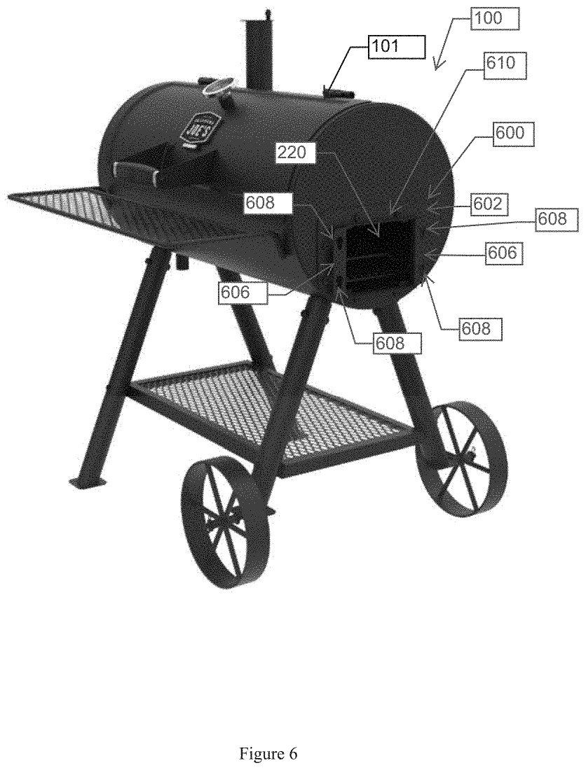

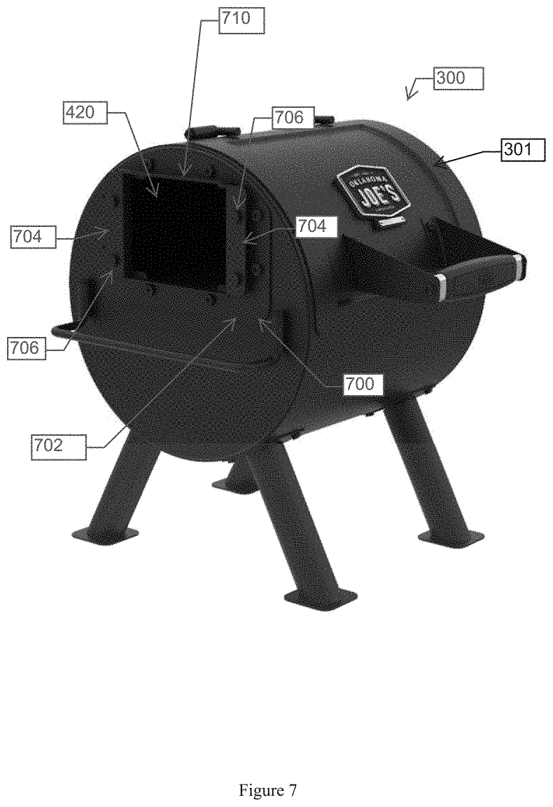

Referring now to FIGS. 6 and 7, perspective views of another embodiment of a coupling is shown. The coupling as illustrated in FIGS. 6-7 comprises a keyhole bracket 600 on the body 101 of main cooking grill 100 and a stud bracket 700 on the body 301 of the offset cylinder 300, although these components may be reversed in other embodiments. The illustrated coupling of FIGS. 6-7 may provide similar functionality to other embodiments described herein by allowing selective attachment/detachment of the cylinders 100, 300. Structures that connect and affix the brackets 600, 700 remain outside the potentially corrosive environment of the heat and combustion products inside the grill 100, the offset cylinder 300, and passageway(s) between them.

The keyhole bracket 600 may define opening 220 into the body 101 of main grill 100 through a conduit or collar 610. A back plate 602 attached to collar 610 may attach to body 101. One or more side flanges 606 may be attached to the collar 610 and thereby spaced apart from the body 101 or back plate 602, similar to previous embodiments. The side flanges 606 may each define one or more keyhole slots 608.

The stud bracket 700 may define opening 420 into body 301 through a conduit or collar 710. The stud bracket 700 may comprise a back plate 702 attached to the collar 710. Opposite the back plate 702 with one or more side flanges 704 may proceed from the collar 710 and thereby be spaced apart from the body 301 or back plate 702, similar to previous embodiments. One or more studs 706 may protrude from the side flanges 704.

The conduits or collars 610, 710 are shown as having a square or rectilinear cross section. While this configuration provides some benefits in terms of geometry and ease of production, other embodiments are not square in cross section (e.g., they may be circular, oblong, or polygonal).

The side flanges 604, 704 may be configured to align such that the keyholes 608 are cooperatively placed with respect to the studs 706 to allow the studs 706 to be inserted into the keyholes 608 when the brackets 600, 700 are coupled to join bodies 101, 301 together. The studs 706 may have a relatively larger head on a relatively narrower shaft. The keyholes 608 have a larger opening adjacent to a narrower slot. The head of the studs 706 may fit into the respective opening of the keyholes 608 but cannot be moved through the narrower slot. In the example shown, the studs 706 are inserted into the respective keyholes 608 when the cylinder 300 is slightly elevated relative to its proper attached position on the body 101. When the body 301 is lowered, the slots of the keyholes 608 retain the studs and thereby the body 301. The body 301 then remains in place under force of gravity until it is elevated and removed from main body 101. It can be seen that the mating elements that establish the connection of the brackets 600, 700 are not exposed to hot and potentially corrosive gases and therefore are less likely to deteriorate and become non-functional.

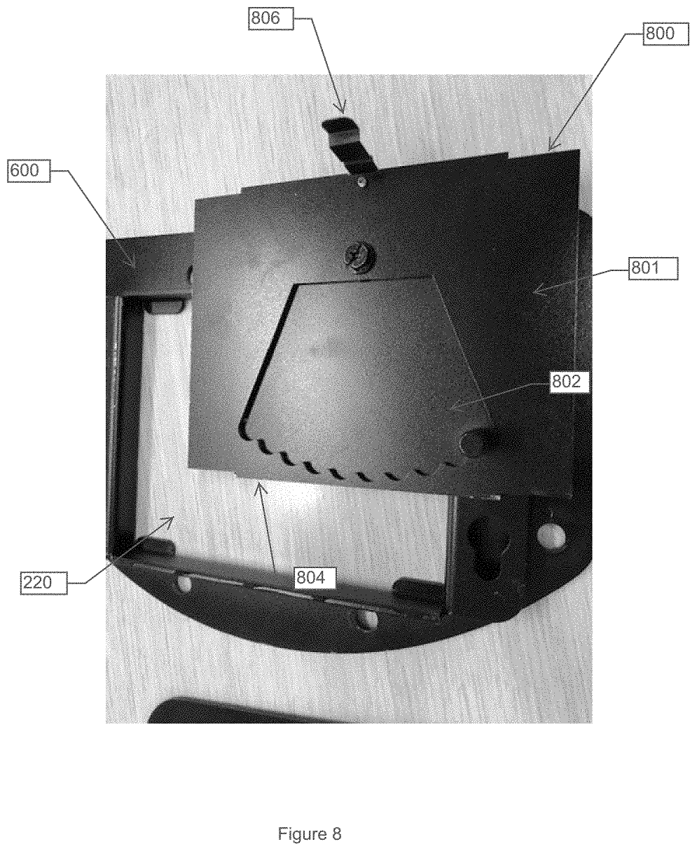

Referring now to FIG. 8 a perspective view of a keyhole bracket 600 with removable vent cover 800 according to the present disclosure is shown. It should be understood that any of the brackets of the present disclosure could be outfitted with a cover similar to cover 800. The cover 800 may be used when the bracket 600 is not attached to bracket 700, for example. The cover 800 may include an indexed vent 802 situated within a cover plate 801.

The cover plate 801 may be sized to close the opening 220 or other opening on another bracket. The cover may have a lower lip 804 and an upper spring clip retainer 806 that allows it to be selectively attached to and retained by the bracket 600. In other embodiments, other attachment/detachment mechanisms may be used. In one example, the cover plate 801 provides studs that fit into keyhole slots 608.

It should be understood that the bracket 600 could be affixed to the body 301 of the offset smoker 300; and the bracket 700 could be affixed to the body 101 of the grill 100. In such case the brackets 600, 700 and their associated components would be reversed from how they are illustrated but the operation of the coupling system would otherwise be substantially similar.

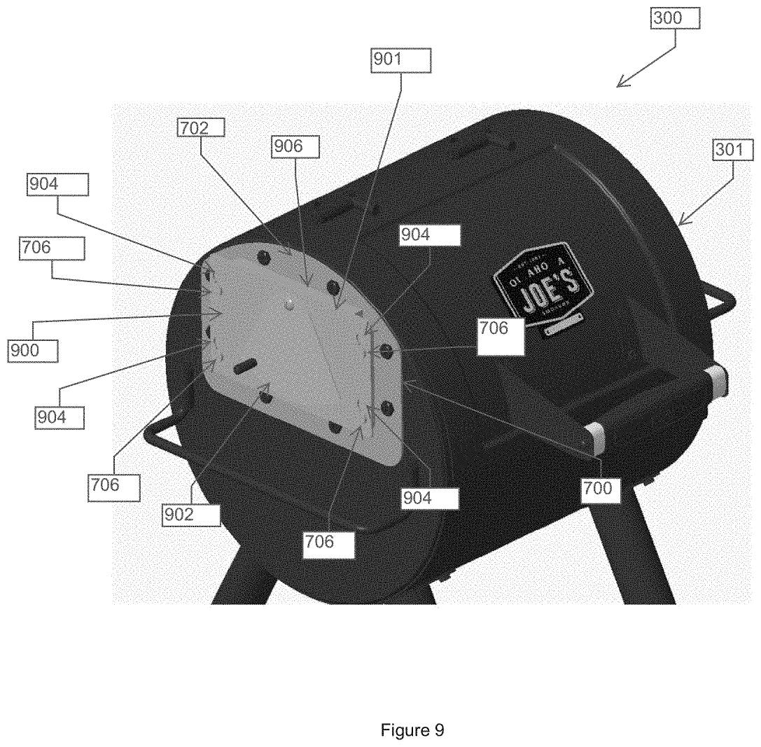

Referring now to FIG. 9 a perspective end view of an offset smoker 300 with a stud bracket 700 and attached removable vent cover 900 according to the present disclosure is shown. The vent cover 900 may include a cover plate 901 that blocks air and gas flow from the bracket 700. The cover 900 may include a damper or an indexed damper 902 for adjusting air flow to or from the offset smoker 300.

The cover plate 901 may be sized to generally cover any opening of the bracket 700 into the body 301 of the smoker 300. Where the cover plate 901 meets the flanges of the bracket 700, and the studs 706, a number of corresponding keyhole slots 904 may be defined. The keyhole slots 904 may receive the suds 904 to lock the plate 901 into position. The keyhole slots 904 may have a wider end to accept to a wider distal end of the studs 706, and an adjacent relatively narrower portion to slide behind the wider distal end, similar to the stud and keyhole mechanism described above.

The cover plate 901 may lock into place by gravity (e.g., where the narrower end of the keyhole slots 904 is downward) or a lip or flexible member 906 may be provided that fits over the collar 710 as shown.

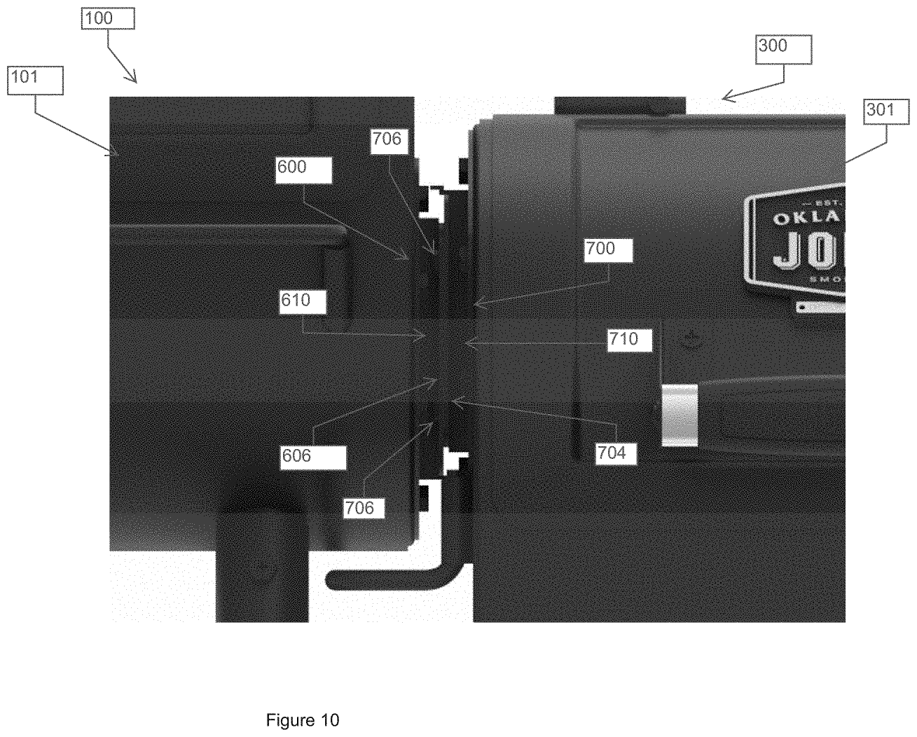

Referring now to FIG. 10 is a side closeup view of the cooking grill 100 joined to the offset smoker box 300 box of FIG. 7 utilizing their respective brackets to form an offset smoker. The studs 706 (FIG. 7) have been mated with the keyhole slots 608 (FIG. 6) to join the brackets 600, 700 together, and thereby join the offset smoker box 300 to the grill 100 to create the offset smoker. From this view it can be appreciated how the collars 610, 710 of the respective brackets 600, 700 provide isolation of the studs 706 and keyhole slots 608 from corrosive internal environments of the grill 100 and/or offset smoker box 300. The spacing of the studs 706 and keyhole slots 608 from the respective bodies 301/101 also allows for easier tool-free coupling and decupling of the offset smoker box 300 and grill 100.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

The term “selective” or “selectively,” unless otherwise indicated, is taken to mean that the operation or function is capable of being performed by the structure or device in reference, but the operation or function may not occur continuously or without interruption. Furthermore, a selective or selectively performed operation may be one that the user or operator of a device or method may choose whether or when to perform, but the function or operation is nevertheless fully operative on or within the relevant device, machine, or method and the same includes the necessary structure or components to perform such operation.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A coupling system for joining a first cooking component body to a second cooking component body comprising:
a first bracket affixed to the first cooking component body and defining a first passageway therethrough; and
a second bracket affixed to the second cooking component body and defining a second passageway therethrough;
wherein the first and second brackets may be joined together to form a continuous passageway from the first cooking component body to the second cooking component body.

2. The system of claim 1, further comprising a slot defined by a fold at a top of the second bracket that receives a tab defined at a top of the first bracket.

3. The system of claim 2, wherein:
the first bracket comprises:
a first back plate affixed to the first cooking component body and a first collar proceeding therefrom;
a first pair of side flanges on the first bracket collar; and
a lower flange on the first bracket collar, the lower flange having at least a first laterally oriented sleeve thereon; and
the second bracket comprises:
a back plate affixed to the second cooking component and a collar proceeding therefrom;
a second pair of side flanges on the second bracket collar;
a lower flange on the second bracket collar, the lower flange having at least a second laterally oriented sleeve thereon; and
the coupling system further comprises a removable pin proceeding through the first laterally oriented sleeve on the first bracket collar and the second laterally oriented sleeve on the second bracket collar.

4. The system of any of claim 3, further comprising a pair of spaced apart protruding tabs, one on each of the first pair of slide flanges on the first bracket collar.

5. The system of claim 4, further comprising an end plate sized to be fitted against the first pair of side flanges of the first bracket between the spaced apart protruding tabs when the first and second brackets are separated, having a third laterally oriented sleeve to receive the removable pin when fitted onto the side flanges, and having a top slot to receive the tab when fitted onto the side flanges, the end plate providing a damper valve to control airflow into and out of the first passageway.

6. The system of claim 4, further comprising an end plate with protruding tabs sized to be fitted onto the second pair of side flanges of the second bracket with the tabs outside the side flanges when the first and second brackets are separated, the end plate further having a top tab fitting into the slot of the second bracket, and providing a third laterally oriented sleeve to receive the removable pin when the removable pin is also inserted into the second laterally oriented sleeve, the end plate providing a damper valve to control air flow into and out of the second passageway.

7. The system of claim 1 wherein the first bracket comprises a first set of studs that selectively fit with a first set of keyhole slots defined in the second bracket.

8. The system of claim 7, wherein the set of keyhole slots are defined in a pair of flanges that extend laterally from a collar of the second bracket.

9. The system of claim 8, wherein the set of studs are affixed to a pair of side flanges that extend laterally from the first bracket.

10. The system of claim 8, wherein:
the collar of the first bracket is affixed to the first cooking component body by a first backing plate on an opposite end of the first collar from the second set of side flanges; and
the collar of the second bracket is affixed to the second cooking component by a second backing plate on an opposite end of the second collar from the first set of side flanges.

11. The system of 10, further comprising an end plate defining a second set of keyhole slots that receives the first set of studs such that the end plate covers the first bracket when the first and second brackets are separated, the end plate providing a damper valve to control air flow into and out of the first passageway.

12. The system of claim 10, further comprising an end plate supporting a second set of studs such that the end plate covers the second bracket when the first and second brackets are separated, the end plate providing a damper valve to control air flow into and out of the passageway.

13. A coupling system for joining a first cooking component body to a second cooking component body comprising:
a first bracket affixed to the first cooking component body defining a first passageway through the first bracket; and
a second bracket affixed to the second cooking component body and defining a second passageway through the second bracket;
wherein the first and second brackets may be joined together to form a continuous passageway from the first cooking component body to the second cooking component body; and
wherein the first bracket defines a first pin passageway and the second bracket defines a second pin passageway such that the first and second pin passageways align to receive a retaining pin when the first and second bracket are joined together.

14. The system of claim 13, further comprising a tab and slot arrangement between the first bracket and the second bracket such that the tab is retained in the slot when the first and second brackets are joined together.

15. The system of claim 14, wherein the tab and slot arrangement and the first and second brackets are spaced apart from the respective cooking component bodies by first and second collars on the first and second brackets defining the first and second passageways, respectively.

16. The system of claim 15, further comprising at least one end plate defining a third pin passageway such that the end plate fits over the first passageway when the first and second brackets are separated and the retaining pin is inserted through the first and third pin passageways.

17. A coupling system for joining a first cooking component body to a second cooking component body comprising:
a first bracket affixed to the first cooking component body and defining a first passageway through the first bracket;
a second bracket affixed to the second cooking component body and defining a second passageway through the second bracket;
a first set of studs affixed to the first bracket; and
a first set of key slots defined in the second bracket;
wherein the first and second brackets may be joined together to form a continuous passageway from the first cooking component body to the second cooking component body when the first set of studs are received by the first set of key slots; and
the first set of studs and the first set of key slots are spaced apart from the first component cooking body and the second component cooking body by first and second collars of the first and second brackets, respectively.

18. The system of claim 17, wherein the first bracket defines a first set of flanges affixed to the first collar to which the first set of studs are affixed, and the second bracket defines a second set of flanges in which the first set of key slots are defined.

19. The system of claim 18, further comprising an end plate defining a second set of key slots that receives the first set of studs and blocks the first passageway when the first and second brackets are separated, the end plate having a damper.

20. The system of claim 18, further comprising an end plate defining a second set of studs that are received by the first set of key slots and blocks the second passageway when the first and second brackets are separated.
